(19) United States
(12) Patent Application Publication
(10) Pub. No.: US 2019/0161178 A1
(43) Pub. Date: May 30, 2019

(54) UNMANNED AERIAL VEHICLE AND PROPELLER THEREOF

(71) Applicant: Coretronic Intelligent Robotics Corporation, Hukou Township (TW)

(72) Inventors: SHIH-HANG LIN, Hukou Township (TW); YING-CHIEH CHEN, Hukou Township (TW)

(21) Appl. No.: 16/206,988

(22) Filed: Nov. 30, 2018

(30) Foreign Application Priority Data
Nov. 30, 2017 (CN) 201711237297.3

(51) Int. Cl. B64C 27/00; B64C 27/473; B64C 39/02

(52) U.S. Cl. CPC B64C 27/008; B64C 27/473; B64C 39/024; B64C 2201/165; B64C 2201/042; B64C 2201/108; B64C 2201/027

(57) ABSTRACT

An unmanned aerial vehicle includes a body, a plurality of cantilevers and a plurality of driving components. Each cantilever has a first end and a second end. Each first end is opposite to the corresponding second end. The first ends are connected to the body. The driving components are respectively connected to the second ends of the cantilevers. Each driving component includes a motor and a plurality of paddles. The motor has a shaft. The propeller is connected to the shaft and includes a balance disc and a plurality of paddles. The balance disc is connected to the motor. The paddles are connected to the balance disc. The balance disc has a plurality of counterweight holes. The counterweight holes are used to be disposed with the at least one counterweight block. A propeller is also provided.

### CROSS-REFERENCE TO RELATED APPLICATION

THIS APPLICATION CLAIMS THE PRIORITY BENEFIT OF CHINA APPLICATION (CN201711237297.3 FILED ON NOV. 30, 2017). THE ENTIRETY OF THE ABOVE-MENTIONED PATENT APPLICATION IS HEREBY INCORPORATED BY REFERENCE HEREIN AND MADE A PART OF THIS SPECIFICATION.

### FIELD OF THE INVENTION

The invention relates to an aircraft, and more particularly to an unmanned aerial vehicle and a propeller thereof.

### BACKGROUND OF THE INVENTION

An unmanned aerial vehicle is a flying vehicle not requiring a pilot for piloting and can be controlled via wireless communication or fly autonomously. According to the categories of technology, the unmanned aerial vehicles include fixed-wing aircraft, rotorcraft, etc. The fixed-wing aircrafts generally use automatic driving and have advantages of flying fast, long flight distance. However, the fixed-wing aircrafts need a runway to take off and land. The rotorcrafts generally use manual remote control, take-off and landing is less restricted. However, the rotorcrafts have a slower flight speed and a shorter flight distance.

Currently, the balance test for the propeller of the rotorcraft is generally static balance test. If the test fails, the shape of the propeller is sharpened to pass the static balance test. However, even the static balance test passed, the dynamic balance test may not pass. In prior art, the level of dynamic balance is generally between G40-G100.

Since the propeller is the key component of the rotorcraft, the propeller's balance has a great impact on the service life of the motor. Even the balance of the motor itself is very good, the vibration of the motor will be magnified when the balance of the adopted propeller is poor. If the motor is operated under excessive vibration for a long time, the service life of the motor will be shortened.

The information disclosed in this “BACKGROUND OF THE INVENTION” section is only for enhancement understanding of the background of the invention and therefore it may contain information that does not form the prior art that is already known to a person of ordinary skill in the art. Furthermore, the information disclosed in this “BACKGROUND OF THE INVENTION” section does not mean that one or more problems to be solved by one or more embodiments of the invention were acknowledged by a person of ordinary skill in the art.

### SUMMARY OF THE INVENTION

The invention provides an unmanned aerial vehicle to improve reliability.

The invention further provides a propeller to improve the service life of the motor therewith.

Other objectives and advantages of the invention can be further understood from the technical features disclosed in the invention.

In order to achieve one or a part or all of the above objectives or other objectives, an embodiment of the invention provides an unmanned aerial vehicle. A dynamic balance of the unmanned aerial vehicle is adjusted by at least one counterweight block. The unmanned aerial vehicle includes a body, a plurality of cantilevers and a plurality of driving components. Each of the cantilevers has a first end and a second end. Each of the first ends is opposite to the corresponding second end. The first ends are connected to the body. The driving components are respectively connected to the second ends of the cantilevers. Each of the driving components includes a motor and a plurality of paddles. The motor has a shaft. The propeller is connected to the shaft and includes a balance disc and a plurality of paddles. The balance disc is connected to the motor. The paddles are connected to the balance disc. The balance disc has a plurality of counterweight holes. The counterweight holes are used to be disposed with the at least one counterweight block.

In order to achieve one or a part or all of the above objectives or other objectives, an embodiment of the invention provides a propeller connected to a motor and for disposing at least one counterweight block. The propeller includes a balance disc and a plurality of paddles. The balance disc is used to connect with the motor. The paddles are connected to the balance disc. The balance disc has a plurality of counterweight holes. The counterweight holes are used to be disposed with the at least one counterweight block.

In summary, the propeller of the embodiment of the invention has a balance disc, and the counterweight hole of the balance disc can be disposed with a counterweight block. Therefore, the dynamic balance of the propeller can be improved by the arrangement of the counterweight blocks. As a result, the service life of the motor can be increased, thereby improving the reliability of the unmanned aerial vehicle according to the embodiment of the invention.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a three dimensional view of an unmanned aerial vehicle in accordance with an embodiment of the invention;

FIG. 2 is a partial three dimensional view of a propeller in accordance with an embodiment of the invention; and

FIG. 3 is a partially exploded three dimensional view of a propeller in accordance with another embodiment of the invention.

### DETAILED DESCRIPTION OF PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top”, “bottom”, “front”, “back”, etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including”, “comprising”, or “having” and variations thereof herein is meant to encompass the items listed thereafter and equivalents thereof as well as additional items. Unless limited otherwise, the terms “connected”, “coupled”, and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

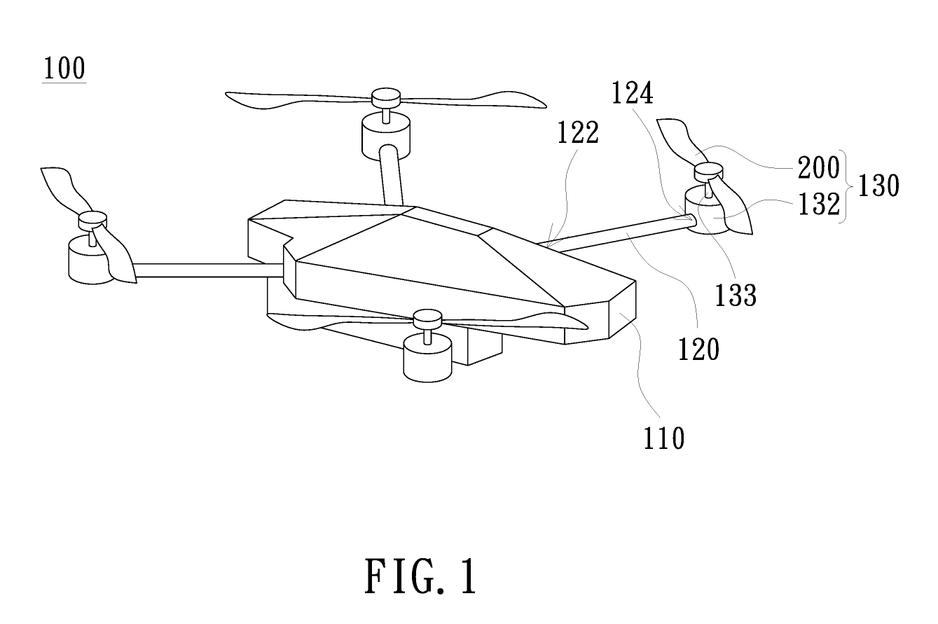

FIG. 1 is a three dimensional view of an unmanned aerial vehicle (UAV) in accordance with an embodiment of the invention. Referring to FIG. 1, the dynamic balance of the unmanned aerial vehicle 100 of the embodiment is adjusted by employing at least one counterweight block (not shown). The unmanned aerial vehicle 100 includes a body 110, a plurality of cantilevers 120 and a plurality of driving components 130. Each cantilever 120 has a first end 122 and a second end 124. Each first end 122 is opposite to the corresponding second end 124, and the first end 122 is connected to the body 110. The driving components 130 are respectively connected to the second ends 124 of the cantilevers 120, and each of the driving components 130 includes a motor 132 and a propeller 200. The motor 132 has a shaft 133, and the propeller 200 is connected to the shaft 133. The propeller 200 is, for example, pivotally connected to the shaft 133, and the shaft 133 drives the propeller 200 to rotate. In addition, the embodiment is exemplified by having four cantilevers 120 and the second end 124 of each cantilever 120 is connected to one driving component 130. However, the invention does not limit the number of the cantilevers 120 and the number of the driving components 130 connected to the cantilever 120.

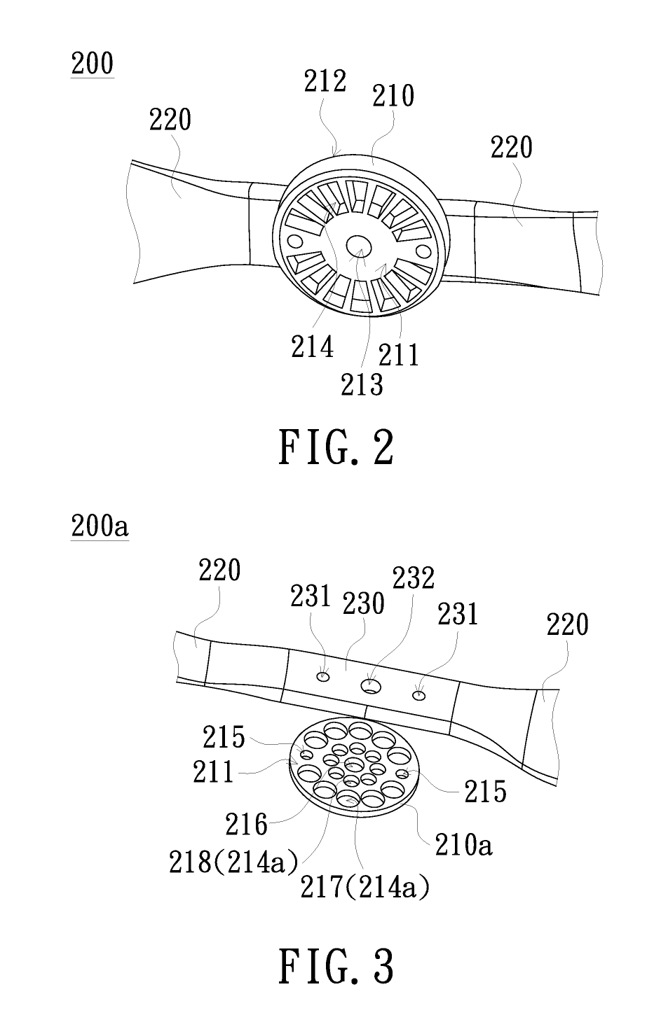

FIG. 2 is a partial three dimensional view of a propeller in accordance with an embodiment of the invention. Referring to FIG. 2, the propeller 200 includes a balance disc 210 and a plurality of paddles 220, wherein the paddles 220 are connected to the balance disc 210. Specifically, the balance disc 210 is connected between the paddles 220. The embodiment is exemplified by that the two paddles 220 are symmetrically connected to the balance disc 210. However, the invention does not limit the number of paddles. In addition, referring to FIG. 1 and FIG. 2, the balance disc 210 is connected to the motor 132 in FIG. 1. In the embodiment, the balance disc 210 has a first surface 211 and a second surface 212, wherein the first surface 211 faces the motor 132 and the second surface 212 is opposite to the first surface 211. The center of the first surface 211 is, for example, provided with a connecting hole 213, and the balance disc 210 is connected to the shaft 133 of the motor 132 through the connecting hole 213. In addition, the balance disc 210 has a plurality of counterweight holes 214, and the counterweight holes 214 are configured to be disposed with at least one counterweight block (not shown).

In the embodiment, the counterweight holes 214 are, for example, located on the first surface 132 of the balance disc 210, and the counterweight holes 214 are, for example, blind holes. The counterweight holes 214 are, for example, arranged along the periphery of the first surface 132 of the balance disc 210. The counterweight block may be a metal block or clay that is adhesively secured in the counterweight hole 214, but not limited thereto. In addition, the balance disc 210 and the paddle 220 of the embodiment are integrally formed, for example. The material of the propeller 200 can be wood, carbon fiber, plastic or other suitable material. The balance disc 210 is a circular disc, for example. However, the balance disc 210 may have other suitable shapes, which are not limited in the invention.

The propeller 200 of the embodiment has the balance disc 210 and the balance disc 210 has a plurality of counterweight holes 214, thus, after using the instrument for testing the dynamic balance, the counterweight hole 214 in the corresponding position is provided with a counterweight block of a corresponding counterweight according to the position and size of the imbalance obtained by the test results, so as to improve dynamic balance. Compared with the prior art, in the embodiment, adjusting the dynamic balance by using the counterweight block can increase the level of dynamic balance to G2.5-G6.3 in a short time. Therefore, the over vibration of the motor 132 due to the poor dynamic balance of the propeller 200 can be avoided, thereby increasing the service life of the motor 132 and further improving the reliability of the unmanned aerial vehicle 100 of the embodiment.

The counterweight hole 214 of the embodiment is exemplified by a blind hole; however, the blind hole may also be replaced by a through hole in another embodiment. In addition, the balance disc 210 and the paddle 220 of the embodiment are integrally formed; however, the balance disc 210 and the paddle 220 may be designed to two components detachable from each other in another embodiment.

FIG. 3 is a partially exploded three dimensional view of a propeller in accordance with another embodiment of the invention. Referring to FIG. 3, the propeller 200a of the embodiment is similar to the propeller 200 of FIG. 2, and the main difference lies in that the balance disc 210a and the paddle 220a of the propeller 200a are two components detachable from each other. The propeller 200a further includes, for example, a connecting portion 230 connected between the paddles 220a and for connecting with the balance disc 210a. The paddle 220a and the connecting portion 230 are integrally formed, for example. In addition, the connecting portion 230 has, for example, a plurality of locking holes 231 (two are taken as an example in FIG. 3), and the balance disc 210a has a plurality of locking holes 215 corresponding to the locking holes 231, for example. Thus, by locking the locking members to the corresponding locking holes 231 and 215, the paddle 220a is connected to the balance disc 210a through the connecting portion 230. The invention does not limit the connection between the connecting portion 230 and the balance disc 210a. For example, the connecting portion 230 and the balance disc 210a may be connected by means of engagement or adhesion. In addition, the connecting portion 230 has a shaft hole 232 for example, the balance disc 210a has a shaft hole 216 for example, and the shaft holes 232 and 216 are used for connecting with the shaft of the motor.

The counterweight hole 214a of the balance disc 210a of the embodiment is, for example, a through hole, but it may also be a blind hole. In addition, the counterweight holes 214a include, for example, a plurality of first counterweight holes 217 and a plurality of second counterweight holes 218. The first counterweight holes 217 are arranged along the periphery of the first surface 211 of the balance disc 210a. The second counterweight holes 218 are arranged in a region surrounded by the first counterweight holes 217. In other words, the counterweight holes 214a of the embodiment are arranged in two inner and outer rings, so that the suitable counterweight hole 214a arranged on the inner and outer rings can be selected for placing the counterweight block.

In summary, the propeller of the embodiment of the invention has a balance disc, and the counterweight hole of the balance disc can be provided with a counterweight block. Therefore, the dynamic balance of the propeller can be improved by the arrangement of the counterweight blocks and the balance can be raised to level of G2.5-G6.3 in a short time. As a result, the service life of the motor can be increased, thereby improving the reliability of the unmanned aerial vehicle according to the embodiment of the invention.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims. Furthermore, the terms such as the first stop part, the second stop part, the first ring part and the second ring part are only used for distinguishing various elements and do not limit the number of the elements.

What is claimed is:

1. An unmanned aerial vehicle, wherein a dynamic balance of the unmanned aerial vehicle is adjusted by at least one counterweight block, and the unmanned aerial vehicle comprising:
a body;
a plurality of cantilevers, wherein each of the cantilevers has a first end and a second end, each of the first ends is opposite to the corresponding second end, and the first ends are connected to the body; and
a plurality of driving components, respectively connected to the second ends of the cantilevers, wherein each of the driving components comprises:
a motor, having a shaft; and
a propeller, connected to the shaft and comprising a balance disc and a plurality of paddles, wherein the balance disc is connected to the motor, the paddles are connected to the balance disc, the balance disc has a plurality of counterweight holes, and the counterweight holes are used to be disposed with the at least one counterweight block.

2. The unmanned aerial vehicle according to claim 1, wherein the counterweight holes are located on a first surface of the balance disc, the first surface faces the motor, a second surface of the balance disc is opposite to the first surface, and the counterweight holes are blind holes.

3. The unmanned aerial vehicle according to claim 1, wherein the counterweight holes are through holes.

4. The unmanned aerial vehicle according to claim 1, wherein the balance disc has a first surface, the first surface faces the motor, a second surface of the balance disc is opposite to the first surface, and the counterweight holes are arranged along a periphery of the first surface.

5. The unmanned aerial vehicle according to claim 1, wherein the balance disc has a first surface, the first surface faces the motor, a second surface of the balance disc is opposite to the first surface, the counterweight holes comprise a plurality of first counterweight holes and a plurality of second counterweight holes, the first counterweight holes are arranged along a periphery of the first surface, and the second counterweight holes are arranged in a region surrounded by the first counterweight holes.

6. The unmanned aerial vehicle according to claim 1, wherein the balance disc is a circular disc.

7. The unmanned aerial vehicle according to claim 1, wherein the balance disc and the paddles are integrally formed or separable from each other.

8. A propeller connected to a motor and for disposing at least one counterweight block, the propeller comprising:
a balance disc, used to connect with the motor; and
a plurality of paddles, connected to the balance disc, wherein the balance disc has a plurality of counterweight holes, and the counterweight holes are used to be disposed with the at least one counterweight block.

9. The propeller according to claim 8, wherein the counterweight holes are located on a first surface of the balance disc, the first surface faces the motor, a second surface of the balance disc is opposite to the first surface, and the counterweight holes are blind holes.

10. The propeller according to claim 8, wherein the counterweight holes are through holes.

11. The propeller according to claim 8, wherein the balance disc has a first surface, the first surface faces the motor, a second surface of the balance disc is opposite to the first surface, and the counterweight holes are arranged along a periphery of the first surface.

12. The propeller according to claim 8, wherein the balance disc has a first surface, the first surface faces the motor, a second surface of the balance disc is opposite to the first surface, the counterweight holes comprise a plurality of first counterweight holes and a plurality of second counterweight holes, the first counterweight holes are arranged along a periphery of the first surface, and the second counterweight holes are arranged in a region surrounded by the first counterweight holes.

13. The propeller according to claim 8, wherein the balance disc is a circular disc.

14. The propeller according to claim 8, wherein the balance disc and the paddles are integrally formed or separable from each other.
